(19) United States
(12) Patent Application Publication
(10) Pub. No.: US 2007/0227952 A1
(43) Pub. Date: Oct. 4, 2007

(54) Device for Filling and Removal of Containers for Sorted Postings

(75) Inventor: Armin Zimmermann, Konstanz (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: Siemens Aktiengeseelschaft, Munich (DE)

(21) Appl. No.: 11/597,764

(22) PCT Filed: Apr. 20, 2005
(86) PCT No.: PCT/EP05/04218

§ 371 Date: Nov. 27, 2006

(30) Foreign Application Priority Data
May 29, 2004 (DE) 102004026363.9

(51) Int. Cl. B07C 3/00

(52) U.S. Cl. 209/44.3

(57) ABSTRACT

In a device for filling containers, the containers are filled with postal items from sorting endpoints of a sorting device, and are transferred into a storage and transport device. Below a sorting endpoint a stop mechanism has an extending part for accepting a container. The extending part has a frame with rotating support rollers. Heights of the support rollers are arranged so that the container is tilted towards a stop at a front free end of the extending part. On a fixed part of the stop mechanism a drive roller is arranged so that a drive roller support surface is raised in relation to a line connecting roller surfaces of the support rollers. Behind the drive roller a further roller is provided, whose support surface is located below the drive roller support surface. Behind a rearmost last roller the storage and transport device is arranged along the sorting endpoints.

The invention relates to a device for filling and removal of containers for sorted postings as claimed in the preamble of claim 1.

In postal sorting machines the postings are sorted in accordance with the intended destinations (address) into compartments referred to as sorting endpoints arranged along a sorting track. As soon as a sorting compartment is full of postings during the sorting operation it must be emptied. The postings are removed manually from the sorting compartment in such cases and laid in a container which is positioned against a stop. Each sorting compartment has such a stop. To fill the container it is pulled out at right angles to the sorting path. Telescopic extendable devices for filling containers are known in this context (DE 199 01 444 C1, U.S. Pat. No. 4,518,160). In such systems the personnel stand at the side of the container in front of the preceding or the following sorting endpoint. There can be a number of filling processes before a container is finally filled.

As soon as the container is completely filled it must be taken away (DE 199 61 513 C1).

This is frequently done manually. The filled container is lifted up and for example placed on an adjacent transport belt or on a shelf. Because of the weight of the filled containers this activity is physically strenuous.

Therefore there is a known device which reduces the load on the personnel when filling and removing the filled containers (EP 1 243 349 A1). The container is transferred by means of a complicated lifting mechanism from its intermediate position onto a transport means which removes it. This is also complex as regards the safety systems since no manual access to the container may be possible while the container is being removed.

In addition the transfer of a container from a ready position horizontally into a filling position, and from this position horizontally onto a transport belt used for removing the containers is known from EP 0 899 026 A1.

The object of the invention is to create a device for filling and removal of containers for sorted postings in which, while retaining the option of manually filling the containers, the full containers can be transported away with little effort without any physical strain.

In accordance with the invention the object is achieved by the features of claim 1.

Below one or more sorting endpoints arranged above each other is located a stop mechanism with an extending part for accepting a container. The extending part of the stop mechanism comprises a frame with rotating support rollers in which the container is displaceably mounted. The support rollers are arranged at such a height that in the rest position the container is tilted towards a stop at the front free end of the extending part. On the fixed part of the stop mechanism one or more drive rollers are arranged to the rear on a shaft to transport the containers such that the drive roller support surface is slightly raised in relation to a straight line connecting the roller surfaces of the support rollers. At least one further roller is provided behind the drive rollers in the direction opposing the extending direction, the support surface of which is located below the support surfaces of the drive rollers. The storage and transport device is then arranged along the sorting endpoints behind the rearmost last further roller. Advantageous embodiments of the invention are set down in the subclaims. Thus it is advantageous for the storage and transport device to be embodied as a controlled, driven transport path running in parallel to the sorting end points arranged next to one another on which the containers arrive via the drive rollers and the further rollers.

It is also advantageous for the extending part of the stop mechanism to have an easy-to-operate telescopic extension mechanism.

To guarantee a safe removal of the containers without additional safety precautions for the operators, it is advantageous to select the coefficient of friction between the drive roller and the container so that the force exerted on the containers does not exceed a defined amount.

So that the operators do not have to constantly monitor the storage and transport device, it is advantageous, if after manual activation of the removal of a container, the process is only started automatically if the storage and transport device is ready to accept the container.

The invention is explained below in an exemplary embodiment with reference to the drawing.

The figures show

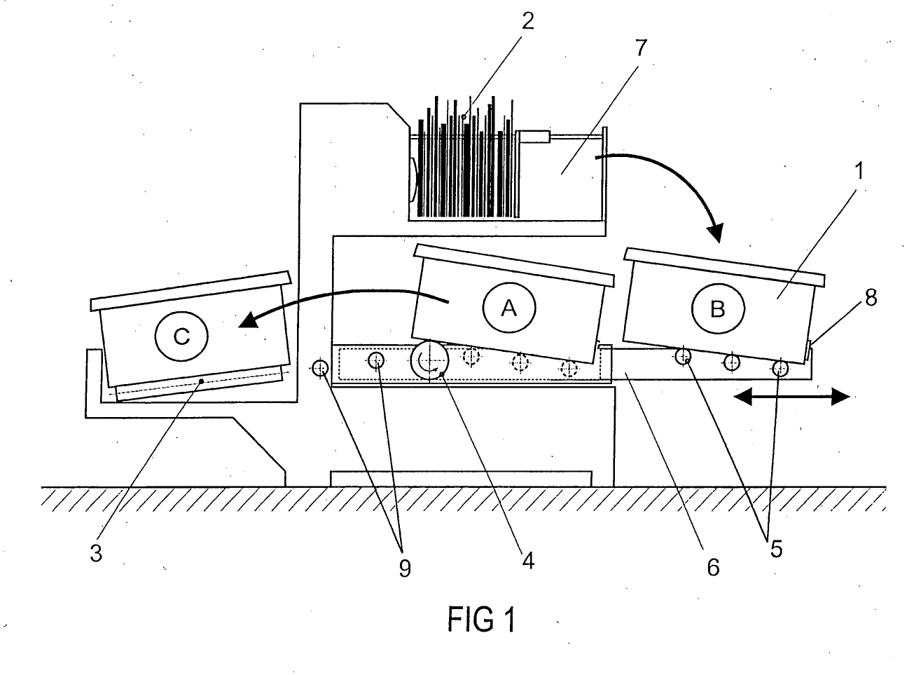

FIG. 1 a schematic cross-sectional diagram of a sorting device at a sorting endpoint,

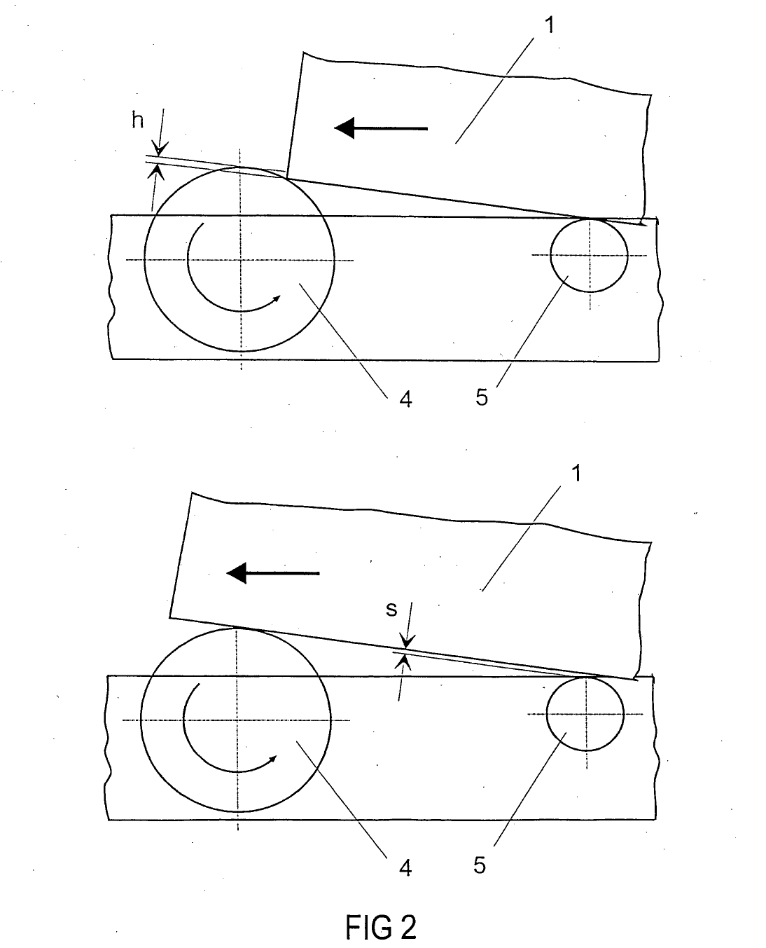

FIG. 2 a schematic diagram of the height relationships between the drive roller and a container.

As shown in FIG. 1, the sorting device has a series of compartments located next to each other as sorting endpoints 7. Below each sorting compartment 7 the sorting device has a stop mechanism, on the extending part 6 of which a container 1 is located for accepting postings from the sorting endpoint 7. This extending part 6 has a telescopic extension and support rollers 5, on which the container 1 is supported. The maximum extension of the telescopic extension is far enough for the container 1 located on it to be positioned before the sorting endpoint 7 to allow it be comfortably unloaded. If a sorting endpoint 7 has reached a certain fill level, a filling sensor not shown in the diagram is used to trigger a signal and the operator pulls out the extending part 6 with the empty or partly filled container 1 and empties the sorting endpoint 7 into the container standing on the extendable part 6 of the stop mechanism which is in the extended state (phase B). As can be seen, the container 1 is supported on the support rollers 5 so that it is tilted forwards and hits a stop 8 located at the front free end of the extending part 6 of the stop mechanism. This roller arrangement gives the container 1 a relatively secure and stable position on the extending part 6 of the stop mechanism even while it is moving. The transverse position of the container 1 also means that the postings 2 have an aligned position in the container 1 towards the front narrower side wall of the container 1. After loading, the container 1 is pushed below the sorting endpoint 7 again. This can be done a number of times until the container 1 is full. As can be seen from FIG. 1, two jointly-driven rotatable drive rollers 4 are located on the rear fixed part of the stop mechanism so that they are located below the rear part of the completely inserted container 1. The drive roller support surface has a slight height offset in relation to the tangential connecting line of the support rollers 5. In this way, when the extending part 6 is pushed in, the rear part of the container 1 is lifted by a small amount h (see FIG. 2) and is thus supported in its inserted state only on the drive roller 4 and on the frontmost support roller 5 located at the stop 8. The bottom of the container is at differing small distances s from the other support rollers 5. If a partly filled container 1 is to be reloaded, the container support is pulled out, the container drops by the amount h and is again supported only on the support rollers 5. The drive roller 4 has a larger diameter and in the non-driven state can easily be rotated, which makes the tangential angle from the arrival point of the container 1 on insertion small and makes the container roll off on insertion and withdrawal onto the drive roller 4 and not slide. If the container 1 is intended for removal, the drive of the drive rollers 4 is activated when the container 1 is inserted (phase A). The friction of the downwards force of the container 1 on the drive rollers 4 causes a force to be transmitted from the drive rollers 4 to the container 1 and the container 1 moves backwards over further rollers 9 tilted slightly onto a storage and transport device 3 designed as a roller track (Phase C). The coefficient of friction between the drive rollers 4 and the container 1 as well as if necessary the circumferential speed of the drive rollers 4 and drive power are arranged so that a minimum transport force is maintained and a defined maximum transport force is not exceeded. This guarantees a safe removal of the containers 1 without additional safety precautions being necessary for the staff. Sensors not shown in the diagram are located on the roller track of the storage and transport device 3 for detection of containers 1, which are connected to the drive controller of the drive rollers 4 and only enable the relevant drive rollers 4 to be driven if the roller track is free to accept the respective container 1.

1. A device for filling and removal of containers for sorted postal items,
wherein the containers are to be filled from sorting endpoints of a sorting device arranged in at least one row,
wherein the containers are configured to be transferred into a storage and transport device,
wherein below at least one sorting endpoint a stop mechanism is located with an extending part for accepting a container,
wherein the extending part of the stop mechanism has a frame with rotating support rollers on which the container is displaceably supported, wherein heights of the support rollers are arranged so that the container is tilted in a rest position towards a stop at a front free end of the extending part,
wherein on a fixed part of the stop mechanism at least one drive roller for transport of the containers which can be rotated to the rear is arranged so that a drive roller support surface is raised slightly in relation to a straight line connecting roller surfaces of the support rollers,
wherein behind the at least one drive rollers against the direction of extension at least one further roller is provided of which the support surface is located below the support surface of the at least one drive rollers, and
behind a rearmost last roller the storage and transport device is arranged along the sorting endpoints.

2. The device of claim 1, wherein the storage and transport device is embodied as a controlled, driven transport path running in parallel to the sorting end points arranged next to one another on which the containers arrive via the drive rollers and the further rollers.

3. The device of claim 1, wherein the extending part of the stop mechanism has a telescopic extension mechanism.

4. The device of claim 1, wherein a coefficient of friction between the drive roller and the container is selected so that a force exerted on the container does not exceed a defined amount.

5. The device of claim 1, wherein after manual enabling of the removal of a container, the process is only started automatically if the storage and transport device is ready to receive the container.
